(19) United States
(12) Patent Application Publication
(10) Pub. No.: US 2025/0030324 A1
(43) Pub. Date: Jan. 23, 2025

(54) METHOD FOR BALANCING A ROTOR OF AN EXTERNAL ROTOR MOTOR

(71) Applicant: BorgWarner Inc., Auburn Hills, MI (US)

(72) Inventor: Silvio Koch, Kirchheimbolanden (DE)

(21) Appl. No.: 18/767,902

(22) Filed: Jul. 9, 2024

(30) Foreign Application Priority Data
Jul. 21, 2023 (DE) 10 2023 119 408.9

(51) Int. Cl. H02K 15/16; H02K 1/2786

(52) U.S. Cl. CPC H02K 15/165; H02K 1/2786

(57) ABSTRACT

A method for balancing a rotor of an external rotor motor is described. The rotor has a back iron ring, permanent magnets attached to the inside of the back iron ring, and a carrier which is attached to the back iron ring and forms a hub for a shaft. Material is removed from the carrier at several points which are arranged at an axial distance from one another in order to eliminate imbalance.

### RELATED APPLICATIONS

This application claims priority to DE 10 2023 119 408.9, filed Jul. 21, 2023, the entire disclosure of which is hereby incorporated herein by reference.

### BACKGROUND AND SUMMARY

This disclosure relates to a method for balancing a rotor of an external rotor motor, wherein the rotor has a back iron ring, permanent magnets attached to the inside of the back iron ring, and a carrier having annularly arranged protrusions and a hub for a shaft.

To eliminate imbalance, material is usually removed from the rotor of an electric motor. For this purpose, the carrier of the external rotor motor disclosed in FR 2 865 584 A has annular protrusions from which material is removed as required.

This disclosure teaches a cost-effective way of improving the balancing of rotors of external rotor motors.

According to this disclosure, material is removed from the carrier at several points to eliminate imbalance. These points are arranged at an axial distance from each other. This facilitates eliminating an imbalance. The axial spacing of the points refers to the respective position on the surface of the carrier before the removal of material begins.

The material can be removed from areas of the carrier that are not designated by a special shape, especially if the walls of the carrier are designed with a greater thickness than would be necessary for mechanical reasons. Another possibility is that the carrier has one or more groups of annular protrusions from which material is removed to eliminate imbalance. The spots at which material is removed from the carrier may therefore be defined by protrusions. For balancing, material is then removed from one or more protrusions (first spots) of a group of protrusions. In addition, for balancing, material may also be removed from one or more spots on the carrier that are at an axial distance from this group of protrusions, i.e., second spots. The second spots may be defined by protrusions or may be another surface of the carrier. The second spots may therefore be one or more protrusions of a second group of protrusions that are axially spaced from this group of protrusions, but it does not have to be.

An advantageous refinement of this disclosure provides that a carrier is used which has two groups of annularly arranged protrusions from which material can be removed to eliminate imbalance. A first group of annularly arranged protrusions can be designed as humps on an end face of the carrier, which protrude in the axial direction. A second group of annular protrusions can be arranged radially outside the first group. In this way, more material is available at different locations, which can be removed for balancing.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a schematic representation of a rotor of an external rotor motor;

FIG. 2 shows a detailed view of the rotor; and

FIG. 3 shows another detailed view of the rotor.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

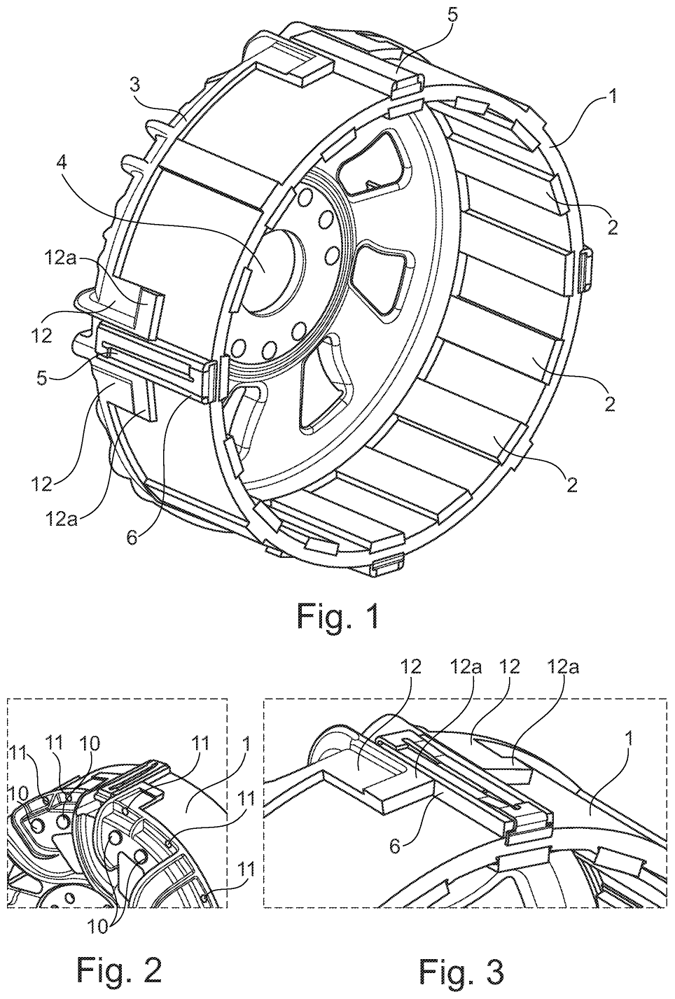

FIG. 1 shows a rotor of an electric motor, more precisely an external rotor motor. The rotor has a back iron ring 1, which may, for example, be formed by a stack of sheet steel, permanent magnets 2 attached to the inside of the back iron ring 1, for example, rare-earth magnets, for example, based on Nd₂Fe₁₄B, and a carrier 3, which has a hub 4 for a shaft and is attached to the back iron ring 1. The carrier 3 may be made of an aluminum-based alloy, for example.

The back iron ring 1 may, for example, be attached to the carrier 3 with brackets 5, which extend along an outer side of the back iron ring 1 and rest with angled end sections against an end face of the back iron ring 1 and an axially opposite face of the carrier 3.

As FIG. 2 shows, the carrier 3 has a first group of annularly arranged protrusions 10, which are designed as bumps protruding in the axial direction on one end face of the carrier 3. To balance the rotor, material can be removed from the protrusions 10 defined by these.

The carrier 3 also has a second group of annular protrusions 11, which are arranged radially outside the first group. Material can also be removed from these protrusions 11 to eliminate imbalance. The protrusions 11 of the second group therefore define second spots of the carrier 3 from which material can be removed to eliminate imbalance. In particular, the protrusions 11 of the second group may be arranged radially outside the first group of protrusions 10 to such an extent that the protrusions 11 of the second group are each arranged at least partially radially further outside than the back iron ring 1.

The second group of annularly arranged protrusions 11 may also be designed as bumps protruding in the axial direction on one end face of the support 3. In the embodiment shown, the second group of protrusions 11 is arranged on an offset ledge of the support 3. The second group of protrusions 11 is therefore arranged at a distance in the axial direction from the first group of protrusions 10, which facilitates balancing.

A further second group of protrusions 12 is arranged on an outer side of the back iron ring 1. Material can also be removed from these protrusions 12 for balancing. The protrusions 12 may be provided in pairs, with one pair of protrusions 12 forming a slot in which a radial protrusion 6 of the back iron ring 1 engages and forms a shaft-hub connection between the back iron ring 1 and the carrier 3.

The protrusions 12 of the further second group extend on the outside of the back iron ring 1 in the axial direction and can have a thickening 12a at their distal end, in particular a thickening 12a that rises in the radial direction, so that more material can be removed to eliminate imbalance without impairing the shaft-hub connection between the back iron ring 1 and the carrier 3.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SYMBOLS

1 Back iron ring
2 Permanent magnets
3 Carrier
4 Hub
5 Brackets
6 Protrusion
10 Protrusions
11 Protrusions
12 Protrusions
12a Thickening

What is claimed is:

1. A method for balancing a rotor of an external rotor motor, the rotor having a back iron ring, permanent magnets attached to the inside of the back iron ring, and a carrier attached to the back iron ring and forming a hub for a shaft, said method comprising:
removing material from the carrier at several spots arranged at an axial distance from one another in order to eliminate imbalance.

2. The method according to claim 1, wherein a first spot is at least one protrusion of a first group of annularly arranged protrusions on an end face of the carrier.

3. The method according to claim 1, wherein a second spot is at least one protrusion of a second group of annularly arranged protrusions.

4. The method according to claim 3, wherein the protrusions of the second group are arranged radially outside the first group.

5. The method according to claim 3, wherein the protrusions of the first group and the protrusions of the second group are arranged as bumps projecting in the axial direction on an end face of the carrier.

6. The method according to claim 3, wherein the protrusions of the second group are each arranged at least partially radially further outwards than the back iron ring.

7. The method according to claim 3, wherein the second group of protrusions of the carrier is arranged on an outer side of the back iron ring.

8. The method according to claim 7, wherein the protrusions of the second group are each arranged in pairs and define between them a slot in which a radial protrusion of the back iron ring engages.

9. The method according to claim 7, wherein the protrusions of the second group extend along the outside of the back iron ring and have a thickening at their distal end.

10. The method according to claim 9, wherein the thickening rises in a radial direction.

11. The method according to claim 3, wherein the second group of protrusions is arranged at a distance in the axial direction from the first group of protrusions.

12. The method according to claim 1, wherein the carrier is made of an aluminum- based alloy.

13. A method for balancing a rotor of an external rotor motor, the rotor having a back iron ring, permanent magnets attached to the inside of the back iron ring, and a carrier attached to the back iron ring and forming a hub for a shaft, said method comprising:
removing material from the carrier at several spots arranged at an axial distance from one another in order to eliminate imbalance;
wherein a first spot is at least one protrusion of a first group of annularly arranged protrusions on an end face of the carrier and a second spot is at least one protrusion of a second group of annularly arranged protrusions;
wherein the second group of protrusions of the carrier is arranged on an outer side of the back iron ring; and
wherein the protrusions of the second group are each arranged in pairs and define between them a slot in which a radial protrusion of the back iron ring engages.
